(19) United States
(12) Patent Application Publication
(10) Pub. No.: US 2015/0323419 A1
(43) Pub. Date: Nov. 12, 2015

(54) APPARATUS AND METHOD FOR PARTIAL MONITORING OF OPTICAL FIBER

(71) Applicants: ELECTRONICS AND TELECOMMUNICATIONS RESEARCH INSTITUTE, Daejeon (KR); TELACE, INC., Seoul (KR)

(72) Inventors: Seung Il MYONG, Daejeon (KR); Jyung Chan LEE, Daejeon (KR); Hun Sik KANG, Daejeon (KR); Won Kyoung LEE, Daejeon (KR); Jin Hee HAN, Seoul (KR)

(21) Appl. No.: 14/682,416

(22) Filed: Apr. 9, 2015

(30) Foreign Application Priority Data
May 9, 2014 (KR) 10-2014-0055808

(51) Int. Cl. G01M 11/00

(52) U.S. Cl. CPC G01M 11/31

(57) ABSTRACT

Provided is an apparatus and a method for partial monitoring of an optical fiber, wherein the optical fiber monitoring apparatus includes a monitoring light transmitter to continuously output a monitoring light to the optical fiber based on a number of measuring time sections generated by dividing an optical fiber monitoring time section, a monitoring light receiver to receive a monitoring light fed back from the optical fiber, measure a monitoring light received based on different measuring time sections for each monitoring light, and store a result of the measuring in a storage medium, and an optical fiber monitor to monitor a status of the optical fiber based on the result of the measuring stored in the storage medium.

### CROSS-REFERENCE TO RELATED APPLICATION

This application claims the priority benefit of Korean Patent Application No. 10-2014-0055808, filed on May 9, 2014, in the Korean Intellectual Property Office, the disclosure of which is incorporated herein by reference.

### BACKGROUND

1. Field of the Invention

The present invention relates to an apparatus and a method for partial monitoring of an optical fiber, and more particularly, to an optical fiber monitoring apparatus and method for increasing an efficiency of a storage medium required for the optical fiber monitoring apparatus by partitioning an optical fiber section to be monitored and monitoring the partitioned optical fiber section.

2. Description of the Related Art

An optical fiber monitoring apparatus refers to an apparatus for monitoring a status of an optical fiber by outputting a monitoring light to the optical fiber.

A conventional optical fiber monitoring apparatus may receive a monitoring light fed back from the optical fiber, measure an optical intensity of the received monitoring light and a point in time at which the monitoring light is received, store the optical intensity and the point in a storage medium, and monitor a status of the optical fiber based on a result of the measuring stored in the storage medium when the monitoring light is fed back from all sections of the optical fiber. Thus, the conventional optical fiber monitoring apparatus may require the storage medium having a large capacity to store all measurement results of all optical fiber monitoring sections because the conventional optical fiber monitoring apparatus monitors the status of the optical fiber using the measurement results after storing the measuring results of all the monitoring sections.

However, increasing a capacity of the storage medium without changing a physical size of the storage medium may incur an increased cost. Similarly, increasing the capacity of the storage medium without a cost increase may cause an increase in the physical size of the storage medium. In addition, the storage medium may occupy a large proportion of a size of the optical fiber monitoring apparatus and a cost required to fabricate the optical fiber monitoring apparatus.

Accordingly, there is a desire for an optical fiber monitoring apparatus and method to decrease a capacity of a storage medium to store measurement results obtained with respect to optical fiber monitoring sections while simultaneously maintaining optical fiber monitoring performances.

### SUMMARY

An aspect of the present invention provides an apparatus and a method for monitoring an optical fiber monitoring section using a storage medium having a smaller capacity than required for monitoring the optical fiber monitoring section.

According to an aspect of the present invention, there is provided an apparatus for monitoring an optical fiber, the apparatus including a monitoring light transmitter to continuously output a monitoring light to the optical fiber based on a number of measuring time sections generated by dividing an optical fiber monitoring time section, a monitoring light receiver to receive a monitoring light fed back from the optical fiber, measure a monitoring light received based on different measuring time sections for each monitoring light and store a result of the measuring in a storage medium, and an optical fiber monitor to monitor a status of the optical fiber based on the result of the measuring stored in the storage medium.

The monitoring light receiver may delay measurement of a received monitoring light until a start point of a measuring time section.

The monitoring light receiver may measure a monitoring light received during a period of time spanning from a start point of a measuring time section to an end point of the measuring section, and store a result of the measuring in the storage medium.

The monitoring light receiver may delete the result of the measuring stored in the storage medium after the optical fiber monitor monitors the status of the optical fiber.

According to another aspect of the present invention, there is provided an apparatus for monitoring an optical fiber, the apparatus including a measuring time section determiner to determine measuring time sections in which a monitoring light fed back from the optical fiber is to be measured based on measuring distance sections generated by dividing an optical fiber monitoring distance section, a monitoring light transmitter to continuously output a monitoring light to the optical fiber based on a number of the measuring time sections, a monitoring light receiver to receive the monitoring light fed back from the optical fiber, measure a monitoring light received based on different measuring time sections for each monitoring light and store a result of the measuring in a storage medium, and an optical fiber monitor to monitor a status of the optical fiber based on the result of the measuring stored in the storage medium.

According to still another aspect of the present invention, there is provided a method of monitoring an optical fiber, the method including continuously outputting a monitoring light to the optical fiber based on a number of measuring time sections generated by dividing an optical fiber monitoring time section, receiving a monitoring light fed back from the optical fiber, measuring a monitoring light received based on different measuring time sections for each monitoring light and storing a result of the measuring in a storage medium, and monitoring a status of the optical fiber based on the result of the measuring stored in the storage medium.

According to yet another aspect of the present invention, there is provided a method of monitoring an optical fiber, the method including determining measuring time sections in which a monitoring light fed back from the optical fiber is to be measured based on measuring distance sections generated by dividing an optical fiber monitoring distance section, continuously outputting a monitoring light to the optical fiber based on a number of the measuring time sections, receiving a monitoring light fed back from the optical fiber, measuring a monitoring light received based on different measuring time sections for each monitoring light and storing a result of the measuring in a storage medium, and monitoring a status of the optical fiber based on the result of the measuring stored in the storage medium.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating an optical fiber monitoring system according to an embodiment of the present invention;

FIG. 2 is a diagram illustrating a process of storing a measurement result by a conventional optical fiber monitoring apparatus;

FIG. 3 is a diagram illustrating an optical fiber monitoring apparatus according to an embodiment of the present invention;

FIG. 4 is a diagram illustrating a process of storing a measurement result by an optical fiber monitoring apparatus according to an embodiment of the present invention;

FIG. 5 is a diagram illustrating an optical fiber monitoring apparatus according to another embodiment of the present invention;

FIG. 6 is a flowchart illustrating an optical fiber monitoring method according to an embodiment of the present invention;

FIG. 7 is a flowchart illustrating a method of monitoring a status of an optical fiber according to an embodiment of the present invention; and

FIG. 8 is a flowchart illustrating operations performed between components of an optical fiber monitoring apparatus according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the accompanying drawings, however, the present invention is not limited thereto or restricted thereby.

When it is determined a detailed description related to a related known function or configuration that may make the purpose of the present invention unnecessarily ambiguous in describing the present invention, the detailed description will be omitted here. Also, terms used herein are defined to appropriately describe the exemplary embodiments of the present invention and thus may be changed depending on a user, the intent of an operator, or a custom. Accordingly, the terms must be defined based on the following overall description of this specification.

An optical fiber monitoring method described herein may be performed by an optical fiber monitoring apparatus described herein.

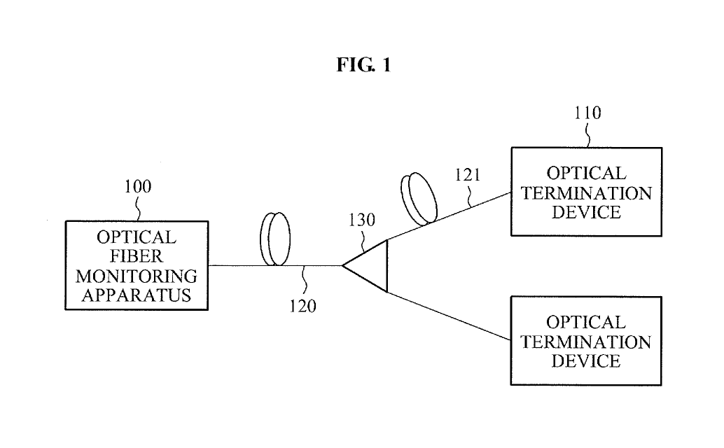

FIG. 1 is a diagram illustrating an optical fiber monitoring system according to an embodiment of the present invention.

Referring to FIG. 1, the optical fiber monitoring system includes an optical fiber monitoring apparatus 100, an optical termination device 110, and an optical fiber 120. The optical fiber monitoring system may be included in a portion of an optical network system to monitor the optical fiber 120 used in the optical network system. For example, the optical fiber monitoring system may be included in an orthogonal frequency division multiple access-passive optical network (OFDMA-PON) system. In such an example, the optical termination device 110 may be included in an optical network unit (ONU). The optical fiber monitoring apparatus 100 may be included in an optical line terminal (OLT).

The optical fiber monitoring apparatus 100 outputs a monitoring light towards the optical termination device 110. A portion of the monitoring light may be fed back to the optical fiber monitoring apparatus 100 while the monitoring light is passing through the optical fiber 120 based on a period of time or a distance. The optical fiber monitoring apparatus 100 measures the monitoring light fed back to the optical fiber monitoring apparatus 100 and stores a result of the measuring in a storage medium. The optical fiber monitoring apparatus 100 determines a status of the optical fiber 120 based on the result of the measuring stored in the storage medium.

For example, when a distance between the optical fiber monitoring apparatus 100 and a location at which the monitoring light is fed back increases, an optical intensity of the monitoring light fed back from the optical fiber 120 may decrease. In addition, when the monitoring light is split by an optical splitter 130, an optical intensity of the monitoring light fed back from the optical fiber 120 subsequent to the splitting may be lower than an optical intensity of the monitoring light fed back from the optical fiber 120 prior to the splitting. The optical fiber monitoring apparatus 100 measures a change in the optical intensity of the monitoring light fed back to the optical fiber monitoring apparatus 100 based on a period of time, and determines a location at which the monitoring light is fed back and a status of the monitoring light based on the measured change in the optical intensity.

The optical fiber monitoring apparatus 100 may include the storage medium having a capacity corresponding to a monitoring period of time or a monitoring distance for determining a monitoring section in the optical fiber 120 to store measurement results. The capacity of the storage medium included in the optical fiber monitoring apparatus 100 may increase based on at least one of a sampling interval, a number of sampling bits, and a measurement distance. The capacity of the storage medium included in the optical fiber monitoring apparatus 100 may limit a size of the optical fiber monitoring apparatus 100 and a cost required for fabricating the optical fiber monitoring apparatus 100.

The capacity of the storage medium, which may indicate a maximum capacity of information that may be stored in the storage medium, may be inversely proportional to a production cost and a physical size of the storage medium. For example, when the capacity of the storage medium is fixed and the production cost for the storage medium is reduced, the physical size of the storage medium may increase and thus, the size of the optical fiber monitoring apparatus 100 may increase. Similarly, when the physical size of the storage medium is minimized, the production cost for the storage medium may increase and thus, a production cost required for fabricating the optical fiber monitoring apparatus 100 may increase.

The optical fiber monitoring apparatus 100 generates a plurality of measuring sections including, for example, a first measuring section and a second measuring section, by dividing an optical fiber monitoring section. The optical fiber monitoring apparatus 100 measures, among monitoring lights fed back from the optical fiber 120, a monitoring light received in a first measuring time section corresponding to the first measuring section. The optical fiber monitoring apparatus 100 stores, in the storage medium, a result of measuring the monitoring light in the first measuring time section. Thus, the optical fiber monitoring apparatus 100 monitors the first measuring section based on the result of measuring the monitoring light in the first measuring time section that is stored in the storage medium.

Similarly, the optical fiber monitoring apparatus 100 measures, among the monitoring lights fed back from the optical fiber 120, a monitoring light received in a second measuring time section corresponding to the second measuring section. The optical fiber monitoring apparatus 100 stores, in the storage medium, a result of measuring the monitoring light in the second measuring time section. Here, the initially stored result of measuring the monitoring light in the first measuring section may be overwritten by the result of measuring the monitoring light in the second measuring section because the initially stored result of measuring the monitoring light in the first measuring section is used to monitor the first measuring section.

As described in the foregoing, the optical fiber monitoring apparatus 100 may continuously output a monitoring light based on the measuring sections generated by dividing the monitoring section and differently set time sections in which each monitoring light fed back from the optical fiber 120 is measured and a result of measuring the monitoring light is stored. Thus, the optical fiber monitoring apparatus 100 may monitor all monitoring sections of the optical fiber 120 using a storage medium having a smaller capacity than required to store all measurement results corresponding to all the monitoring sections of the optical fiber 120. Further, using the storage medium having the smaller capacity than required to store all the results of the measuring may enable a reduction in the production cost for fabricating the optical fiber monitoring apparatus 100 and the size of the optical fiber monitoring apparatus 100.

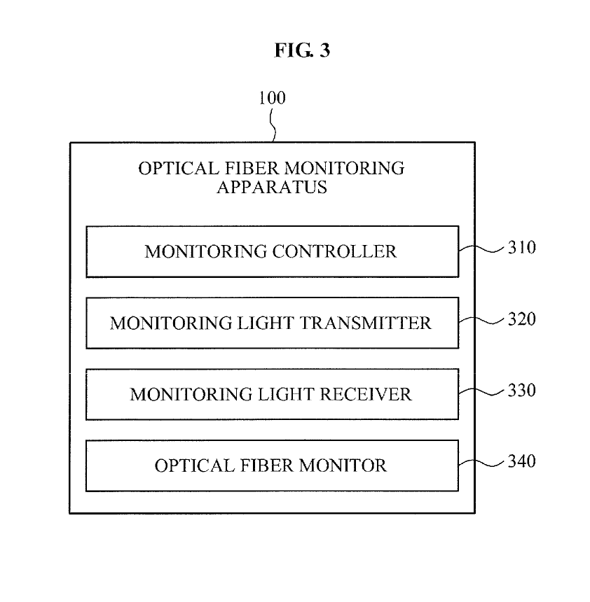

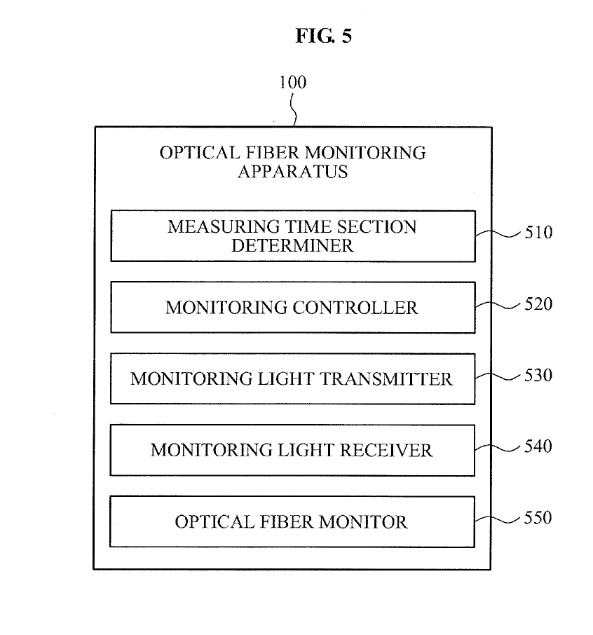

A detailed configuration of the optical fiber monitoring apparatus 100 will be further described with reference to FIGS. 3 and 5.

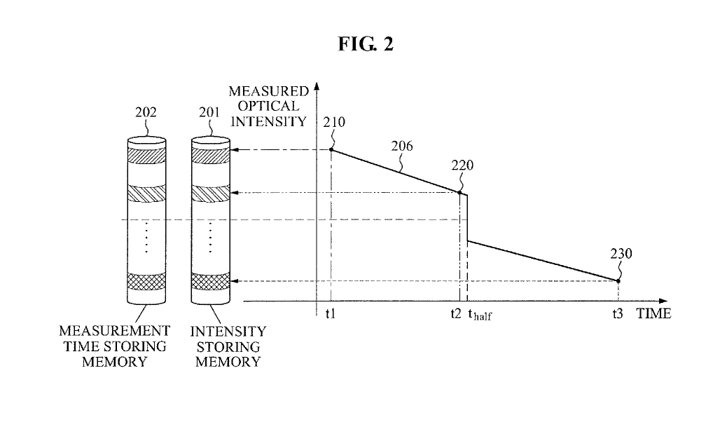

FIG. 2 is a diagram illustrating an example of a process of storing a measurement result by a conventional optical fiber monitoring apparatus.

Referring to FIG. 2, the conventional optical fiber monitoring apparatus outputs a monitoring light to an optical fiber from a point in time “0.” The optical fiber monitoring apparatus receives a monitoring light fed back from the optical fiber and measures an optical intensity of the monitoring light fed back from the optical fiber, and stores a measurement result 200 in a storage medium. The optical fiber monitoring apparatus stores, in the storage medium, a point in time at which the optical intensity of the monitoring light is measured and the measured optical intensity of the monitoring light. As illustrated in FIG. 2, the storage medium includes an intensity storing memory 201 to store the optical intensity of the monitoring light and a measurement time storing memory 202 to store the point in time at which the optical intensity of the monitoring light is measured.

Also, referring to the example of FIG. 2, the optical fiber monitoring apparatus measures an optical intensity 210 of a monitoring light received at a point in time “t₁” and stores the measured optical intensity in the intensity storing memory 201 and t₁ in the measurement time storing memory 202. Similarly, the optical fiber monitoring apparatus measures an optical intensity 220 of a monitoring light received at a point in time “t₂” and stores the measured optical intensity in the intensity storing memory 201 and t₂ in the measurement time storing memory 202. As illustrated in FIG. 2, the optical intensity 220 of the monitoring light measured at t₂ is smaller than the optical intensity 210 of the monitoring light measured at t₁. In addition, the optical fiber monitoring apparatus measures an optical intensity 230 of a monitoring light received at a point in time “t₃” and stores the measured optical intensity in the intensity storing memory 201.

The optical fiber monitoring apparatus then determines a status of an optical fiber monitoring section based on a change in the optical intensities 210 through 230. In addition, the optical fiber monitoring apparatus measures the optical intensities 210 through 230 of the monitoring lights received from t₁ to t₃, and sequentially stores measurement results in the storage medium. Thus, a capacity of the storage medium may be proportionate to ti through t₃ and the optical intensities 210 through 230 of the monitoring lights received from t₁ to t₃.

Accordingly, the conventional optical fiber monitoring apparatus may require the storage medium having a capacity for storing all the optical intensities 210 through 230 of the monitoring lights received from t₁ to t₃.

FIG. 3 is a diagram illustrating the optical fiber monitoring apparatus 100 according to an embodiment of the present invention.

Referring to FIG. 3, the optical fiber monitoring apparatus 100 includes a monitoring controller 310, a monitoring light transmitter 320, a monitoring light receiver 330, and an optical fiber monitor 340.

The monitoring controller 310 controls the monitoring light transmitter 320 and the monitoring light receiver 330 based on measuring time sections generated by dividing an optical fiber monitoring time section. The measuring time sections may be generated by dividing the optical fiber monitoring time section based on a physical size of a storage medium used to store a result of measuring a monitoring light fed back from the optical fiber.

For example, when the optical fiber monitoring time section is divided into two to generate a first measuring time section and a second measuring time section, the monitoring controller 310 may generate two transmission control signals to allow the monitoring light transmitter 320 to transmit a monitoring light to an optical termination device. A transmission control signal may include at least one of an activation information signal to activate the monitoring light transmitter 320 to generate a monitoring light and an optical module ON information signal to provide power to the monitoring light transmitter 320.

In addition, the monitoring controller 310 generates two measurement control signals to allow the monitoring light receiver 330 to set a point in time at which a received monitoring light is to be measured based on the measuring time sections. A measurement control signal may include a control signal to allow the monitoring light receiver 330 to delay, for a period of time, the point in time at which the received monitoring light is to be measured.

In detail, the monitoring controller 310 generates a first measurement control signal to allow the monitoring light receiver 330 to measure a monitoring light received during a period of time spanning from a start point of the first measuring time section to an end point of the first measuring time section based on the first measuring time section and store a result of the measuring in the storage medium. The start point of the first measuring time section may be a point in time at which the monitoring light transmitter 320 transmits the monitoring light.

Also, the monitoring controller 310 generates a second measurement control signal to allow the monitoring light receiver 330 to delay a point in time at which a monitoring light is to be measured until a start point of the second measuring time section based on the second measuring time section. The second measurement control signal may include a control signal to delay the point in time at which the monitoring light is to be measured until the start point of the second measuring time section, and a control signal to measure a monitoring light received during a period of time spanning from the start point of the second measuring time section to an end point of the second measuring time point and store a result of the measuring in the storage medium. Here, the end point of the first measuring time section and the start point of the second measuring time section may be identical to each other, and the end point of the second measuring time point may be a point in time at which the optical termination device receives the monitoring light.

The monitoring light transmitter 320 continuously outputs a monitoring light to the optical fiber based on a number of the measuring time sections. In detail, the monitoring light transmitter 320 transmits the monitoring light to the optical termination device by continuously outputting the monitoring light to the optical fiber based on the transmission control signal received from the monitoring controller 310.

For example, when the monitoring light transmitter 320 receives two transmission control signals from the monitoring controller 310, the monitoring light transmitter 320 may transmit a first monitoring light to the optical termination device. When the optical termination device receives the first monitoring light, the monitoring light transmitter 320 may transmit a second monitoring light to the optical termination device. Here, the monitoring lights continuously transmitted by the monitoring light transmitter 320 may be identical.

The monitoring light receiver 330 receives a portion of the monitoring light output from the optical transmitter 320 to the optical fiber and fed back from the optical fiber. The monitoring light receiver 330 measures a monitoring light fed back from the optical fiber based on different measuring time sections for each monitoring light and stores a result of the measuring in the storage medium. Here, the storage medium may have a capacity to store a result of measuring a monitoring light received during a measuring time section.

The monitoring light receiver 330 controls a point in time at which a received monitoring light is to be measured based on the measurement control signal received from the monitoring controller 310. The monitoring light receiver 330 delays measurement of the received monitoring light until a start point of a measuring time section. When the start point of the measuring time section is reached, the monitoring light receiver 330 may measure the received monitoring light. In addition, the monitoring light receiver 330 may measure the monitoring light received until an end point of the measuring time section, and store a result of the measuring in the storage medium.

For example, the monitoring light receiver 330 may receive the first measurement control signal and the second measurement control signal. The monitoring light receiver 330 may measure a monitoring light received during a period of time spanning from a point in time at which the monitoring light transmitter 320 transmits the monitoring light to the end point of the first measuring time section based on the first measurement control signal. The monitoring light receiver 330 may then store a result of the measuring in the storage medium. The monitoring light receiver 330 may not measure a monitoring light received during a period of time spanning from the end point of the first measuring time section to a point in time at which the optical termination device receives the monitoring light.

When the monitoring light transmitter 320 transmits a second monitoring light, the monitoring light receiver 330 may delay measurement of a received monitoring light until the start point of the second measuring time section based on the second measurement control signal. That is, the monitoring light receiver 330 may not measure the monitoring light received during a period of time spanning from the end point of the first measuring time section to the point in time at which the optical termination device receives the monitoring light and during a period of time spanning from a point in time at which the monitoring light transmitter 320 transmits the monitoring light to the start point of the second measuring time section, and accordingly, not store results of the measuring. The optical fiber monitor 340 monitors a status of a first optical fiber monitoring section using a measurement result stored in the storage medium.

The measurement result stored in the storage medium by the monitoring light receiver 330 may be used to monitor the status of the optical fiber once during the delay and thus, not be used again. Thus, the measurement result stored in the storage medium by the monitoring light receiver 330 may be deleted when the start point of the second measuring time section is reached and a point in time at which the monitoring light receiver 330 receives a monitoring light is reached. That is, the monitoring light receiver 330 may store a result of measuring the monitoring light received during a period of time spanning from the start point of the second measuring time section to the end point of the second measuring time section by overwriting the measurement result already stored in the storage medium with the newly stored measurement result.

In addition, when the optical fiber monitor 340 monitors the status of the optical fiber using the measurement result stored in the storage medium, the monitoring light receiver 330 may delete the used measurement result and thus, secure a space for storing a result of measuring a subsequently received monitoring light.

The optical fiber monitor 340 monitors the status of the optical fiber based on the measurement result stored in the storage medium. In detail, the optical fiber monitor 340 analyzes the stored measurement result during an idle time section spanning from an end point of a measuring time section to a point in time at which the monitoring light transmitter 320 transmits a monitoring light again and during an idle time section spanning from a point in time at which the monitoring light transmitter 320 transmits a monitoring light to a start point of a measuring time section. The optical fiber monitor 340 monitors the status of the optical fiber by performing post correction processing on the analyzed measurement result. Here, the point in time at which the monitoring light transmitter 320 transmits the monitoring light again may be a point in time at which the optical termination device receives the monitoring light or a point in time at which the monitoring light transmitter 320 transmits an N-th monitoring light.

When the status of the optical fiber is less than a threshold value, the optical fiber monitor 340 may send an alarm to inform a manager of an irregularity in the optical fiber. When the status of the optical fiber recovers from the irregularity to be greater than or equal to the threshold value due to handling by the manager or other factors, the optical fiber monitor 340 may cancel the alarm. The optical fiber monitor 340 may display the monitored status of the optical fiber to provide the status to the manager.

As described in the foregoing, the optical fiber monitoring apparatus 100 may monitor all monitoring sections of the optical fiber using the storage medium having a small capacity by dividing an optical fiber monitoring time section into measuring time sections, delaying measurement and storage of a monitoring light fed back from the optical fiber based on the measuring time sections, and repeating the foregoing operation based on a number of the measuring time sections.

In addition, the optical fiber monitoring apparatus 100 may monitor all the monitoring sections of the optical fiber using the storage medium having the small capacity and thus, a cost required for fabricating the optical fiber monitoring apparatus 100 and a size of the optical fiber monitoring apparatus 100 may be reduced.

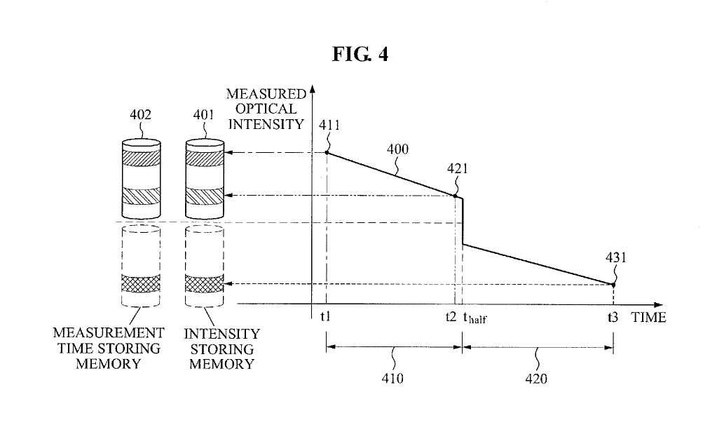

FIG. 4 is a diagram illustrating a process of storing a measurement result by an optical fiber monitoring apparatus according to an embodiment of the present invention.

FIG. 4 illustrates an example of a process in which the monitoring light receiver 330 stores a measurement result 400 obtained by measuring a received monitoring light when an optical fiber monitoring time section is divided into a first measuring time section 410 and a second measuring time section 420.

Referring to FIG. 4, the monitoring light transmitter 320 receives a transmission control signal and outputs a first monitoring light. The monitoring light receiver 330 receives a first measurement control signal. The first measurement control signal may be a control signal that controls the monitoring light receiver 330 to measure an optical intensity of a monitoring light received during a period of time spanning from “t₁” to “t_{half}” with a delay time being set at “0.” Thus, the monitoring light receiver 330 measures the optical intensity of the monitoring light received during the period of time spanning from a point in time “t₁” at which the monitoring light transmitter 320 outputs the monitoring light to “t_{half}.” The monitoring light receiver 330 stores the measurement result 400 in a storage medium. For example, the monitoring light receiver 330 may store the measured optical intensity of the monitoring light in an intensity storing memory 401 and points in time at which the monitoring light is received in a measurement time storing memory 402.

The monitoring light receiver 330 may not measure a monitoring light received during a period of time spanning from t_{half} to a point in time “t₃” at which an optical termination device receives the monitoring light. The optical fiber monitor 340 monitors a status of the optical fiber corresponding to the period of time spanning from ti to t_{half} based on the measurement result 400 stored in the storage medium by the monitoring light receiver 330.

Subsequently, the monitoring light transmitter 320 receives a transmission control signal and outputs a second monitoring light. The monitoring light receiver 330 receives a second measurement control signal. The second measurement control signal may be a control signal that controls the monitoring light receiver 330 to measure an optical intensity of a monitoring light received during a period of time spanning from t_{half} to t₃ with a delay time being set at t_{half} to delay measurement of the received monitoring light until t_{half}. Thus, the monitoring light receiver 330 delays the measurement of the received monitoring light until t_{half} and then measures the optical intensity of the monitoring light received during the period of time spanning from t_{half} to t₃. The monitoring light receiver 330 stores a corresponding measurement result in the storage medium.

The measurement result 400 of measuring the monitoring light received from ti to t_{half} and stored in the storage medium may be used once by the optical fiber monitor 340 and thus, may not be continuously stored. Thus, the monitoring light receiver 330 may store, in the storage medium, the measurement result obtained by measuring the monitoring light received from t_{half} to t₃ by overwriting the measurement result 400 with the measurement result obtained by measuring the monitoring light received from t_{half} t to t₃. In addition, when the optical fiber monitor 340 monitors the status of the optical fiber corresponding to the period of time spanning from t₁ to t_{half}, the optical fiber monitor 340 may delete the measurement result 400 stored in the storage medium by loading the measurement result 400 and thus, a storage space in the storage medium may be secured.

As described in the foregoing, the optical fiber monitoring apparatus 100 may repeat a process of monitoring the status of the optical fiber corresponding to each measuring time section generated by dividing the optical fiber monitoring time section and thus, monitor all sections of the optical fiber. Here, a size of a measurement result to be stored during the process of monitoring the status of the optical fiber may be determined based on the measuring time sections, and be smaller than a size of a measurement result of a monitoring light measured during the optical fiber monitoring time section. The optical fiber monitoring apparatus 100 may monitor all sections of the optical fiber using the storage medium having a smaller capacity than a storage medium having a capacity that may store all measurement results of measuring the optical fiber during the optical fiber monitoring time section.

FIG. 5 is a diagram illustrating the optical fiber monitoring apparatus 100 according to another embodiment of the present invention.

FIG. 5 illustrates an example of the optical fiber monitoring apparatus 100 that monitors an optical fiber by dividing an optical fiber monitoring distance section into a plurality of measuring distance sections.

When an optical fiber monitoring section is divided based on time, sections generated by dividing the optical fiber monitoring section may be different from actual sections of the optical fiber that are generated by dividing the optical fiber monitoring section based on a configuration of the optical fiber including, for example, an optical splitter. Thus, when the measuring time sections are set by dividing the optical fiber monitoring section based on the configuration of the optical fiber and consideration is given to a distance of the optical fiber and a point in time at which a monitoring light is fed back from the optical fiber, the optical fiber monitoring section divided based on the distance may be monitored using a storage medium having a small capacity.

Referring to FIG. 5, the optical fiber monitoring apparatus 100 includes a measuring time section determiner 510, a monitoring controller 520, a monitoring light transmitter 530, a monitoring light receiver 540, and an optical fiber monitor 550.

The measuring time section determiner 510 determines the measuring time sections in which a monitoring light received by the monitoring light receiver 540 is to be measured based on the measuring distance sections generated by dividing an optical fiber monitoring distance section. For example, when a distance between the optical fiber monitoring apparatus 100 and a location at which the monitoring light is fed back from the optical fiber increases, a point in time at which the monitoring light receiver 540 receives the monitoring light fed back from the optical fiber may be delayed.

Thus, when a measuring distance section is farther from the optical fiber monitoring apparatus 100, the measuring time section determiner 510 may increase a delay time of a measuring time section. Conversely, when a measuring distance section is closer to the optical fiber monitoring apparatus 100, the measuring time section determiner 510 may decrease a delay time of a measuring time section to determine the measuring time section.

In addition, when the measuring distance sections are generated by dividing the optical fiber monitoring section based on the configuration of the optical fiber, the measuring time section determiner 510 may determine the measuring time sections based on an existing measurement result. For example, referring back to FIG. 1, when the monitoring distance section is divided into an optical fiber 121 split by the optical splitter 130 and an optical fiber prior to the splitting, the existing measurement result may include a point in time at which an optical intensity of a monitoring light received based on a location of the optical splitter 130 decreases. Here, the measuring time section determiner 510 may determine a measuring time section corresponding to a measuring distance section by setting the point in time at which the optical intensity of the received monitoring light decreases to be a start point of the measuring time section or an end point of the measuring time section.

The monitoring controller 520 controls the monitoring light transmitter 530 and the monitoring light receiver 540 based on the measuring time sections determined by the measuring time section determiner 510. For example, when an optical fiber monitoring time section is divided into two measuring time sections, for example, a first measuring time section and a second measuring time section, the monitoring controller 520 may generate two transmission control signals to allow the monitoring light transmitter 530 to transmit a monitoring light to an optical termination device.

The monitoring controller 520 may also generate two measurement control signals to allow the monitoring light receiver 540 to set a point in time at which a received monitoring light is to be measured based on the measuring time sections. A measurement control signal may include a control signal to allow the monitoring light receiver 540 to delay, for a certain period of time, a point in time at which measurement of a monitoring light is started.

The monitoring light transmitter 530 continuously outputs a monitoring light to the optical fiber based on a number of the measuring time sections. In detail, the monitoring light transmitter 530 receives a transmission control signal from the monitoring controller 520 and transmits the monitoring light to the optical termination device by continuously outputting the monitoring light based on the transmission control signal.

For example, when two transmission control signals are received from the monitoring controller 520, the monitoring light transmitter 530 may transmit a first monitoring light to the optical termination device. When the optical termination device receives the first monitoring light, the monitoring light transmitter 530 may transmit a second monitoring light to the optical termination device. The monitoring lights continuously transmitted by the monitoring light transmitter 530 may be an identical monitoring light.

The monitoring light receiver 540 receives a portion of the monitoring light fed back from the optical fiber, measures the monitoring light fed back from the optical fiber based on different measuring time sections for each monitoring light, and stores a result of the measuring in a storage medium.

Here, a capacity of the storage medium may be suitable for storing a result of measuring a monitoring light received during a measuring time section. When the measuring distance sections are generated based on the configuration of the optical fiber, lengths of the measuring distance sections may be different. The capacity of the storage medium may be determined based on a longest measuring distance section. In detail, the capacity of the storage medium may be suitable for storing the result of measuring the monitoring light received during the measuring time section determined based on the longest measuring distance section.

The monitoring light receiver 540 receives a measurement control signal from the monitoring controller 520, and measures a received monitoring light based on the measurement control signal. The monitoring light receiver 540 delays measurement of the received monitoring light until a start point of a measuring time section. In detail, when the start point of the measuring time section is reached, the monitoring light receiver 540 may measure the received monitoring light. The monitoring light receiver 540 may measure the received monitoring light until an end point of the measuring time section and store a result of the measuring in the storage medium.

When the optical fiber monitor 550 monitors a status of the optical fiber using the result of the measuring stored in the storage medium, the monitoring light receiver 540 may delete the stored result and thus, a space for storing a result of measuring a subsequently received monitoring light may be secured in the storage medium.

The optical fiber monitor 550 monitors the status of the optical fiber based on the result of the measuring stored in the storage medium. In detail, the optical fiber monitor 550 analyzes a measurement result stored in the storage medium during a time section spanning from an end point of a measuring time section to a point in time at which the monitoring light transmitter 530 transmits a monitoring light again and during a time section spanning from a point in time at which the monitoring light transmitter 530 transmits a monitoring light to a start point of a measuring time section. The optical fiber monitor 550 monitors the status of the optical fiber by performing post correction processing on the analyzed measurement result. Here, the point in time at which the monitoring light transmitter 530 transmits the monitoring light again may be a point in time at which the optical termination device receives the monitoring light or a point in time at which the monitoring light transmitter 530 transmits an N-th monitoring light.

In addition, when the status of the optical fiber is less than a threshold value, the optical fiber monitor 550 may send an alarm to inform a manager of an irregularity in the optical fiber. When the status of the optical fiber recovers from the irregularity to be greater than or equal to the threshold value due to a response from the manager or other factors, the optical fiber monitor 550 may cancel the alarm. Also, the optical fiber monitor 550 may display the monitored status of the optical fiber to provide the status to the manager.

As described in the foregoing, the optical fiber monitoring apparatus 100 may divide the optical fiber monitoring time section into the measuring time sections, delay measurement and storage of a monitoring light fed back from the optical fiber based on the measuring time sections, and store a result of measuring the monitoring light fed back from the optical fiber during a measuring time section. In addition, the optical fiber monitoring apparatus 100 may monitor all sections of the optical fiber using the storage medium having a small capacity by repeating the operations described in the foregoing based on a number of the measuring time sections and processing a measurement result stored in the storage medium.

Further, the optical fiber monitoring apparatus 100 may monitor all the sections of the optical fiber using the storage medium having the small capacity and thus, a production cost required for fabricating the optical fiber monitoring apparatus 100 and a size of the optical fiber monitoring apparatus 100 may be reduced.

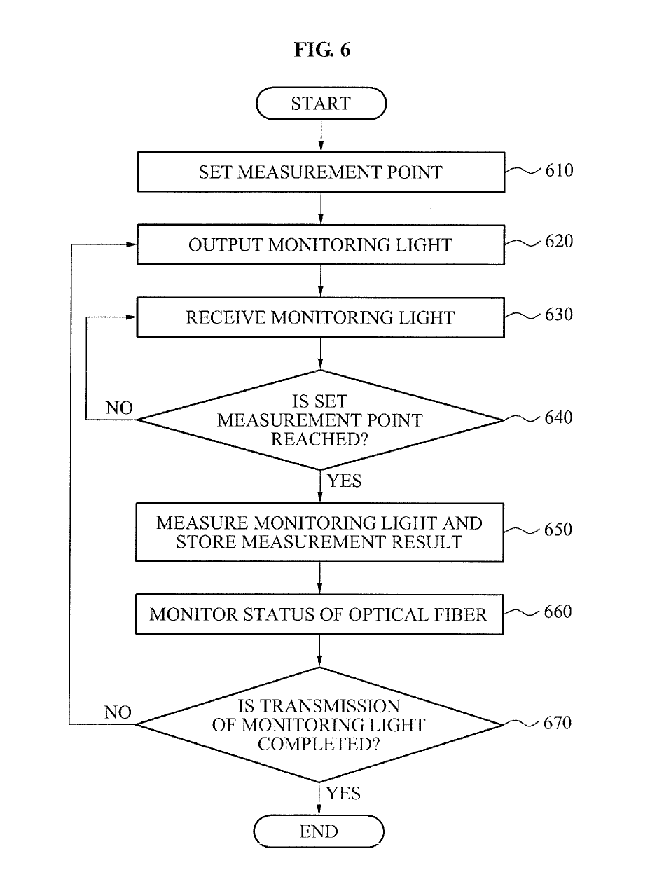

FIG. 6 is a flowchart illustrating an optical fiber monitoring method according to an embodiment of the present invention.

Referring to FIG. 6, in operation 610, the monitoring controller 310 sets a measurement point in time at which a monitoring light received by the monitoring light receiver 330 is to be measured based on measuring time sections generated by dividing an optical fiber monitoring time section. The monitoring controller 310 generates transmission control signals to control the monitoring light transmitter 320 to transmit the monitoring light based on a number of the measuring time sections generated by dividing the optical fiber monitoring time section.

In operation 620, the monitoring light transmitter 320 outputs the monitoring light to an optical fiber based on the transmission control signals generated in operation 610.

In operation 630, the monitoring light receiver 330 receives a portion of the monitoring light output to the optical fiber in operation 620 and fed back from the optical fiber.

In operation 640, the monitoring light receiver 330 verifies whether the measurement point set in operation 610 is reached. For example, when the measurement point is not reached, the monitoring light receiver 330 may repeat operation 630 until the measurement point is reached and delay measurement of the monitoring light received in operation 630. Conversely, when the measurement point is reached, the monitoring light receiver 330 may perform operation 650.

In operation 650, the monitoring light receiver 330 measures the monitoring light received in operation 630. The monitoring light receiver 330 measures a monitoring light received until an end point of a measuring time section and stores a result of the measuring in a storage medium.

In operation 660, the optical fiber monitor 340 monitors a status of the optical fiber based on the result of the measuring stored in the storage medium. After the optical fiber monitor 340 monitors the status of the optical fiber using the stored result, the monitoring light receiver 330 deletes the stored result and thus, a space for storing a result of measuring a subsequently received monitoring light may be secured in the storage medium.

In operation 670, the monitoring light transmitter 320 verifies whether all monitoring lights are transmitted in operation 620 based on a number of the transmission control signals generated in operation 610.

For example, when the number of the transmission control signals generated in operation 610 is three, the monitoring light transmitter 320 may verify whether operation 620 is repeated three times. When operation 620 is repeated less than three times, there may be at least one measuring time section during which the monitoring light received in operation 630 is not measured. Accordingly, there may be a section of the optical fiber that is not monitored. All sections of the optical fiber may be monitored when the monitoring light transmitter 320 performs operation 620 three times in succession and the monitoring light receiver 330 performs operations 630 through 650.

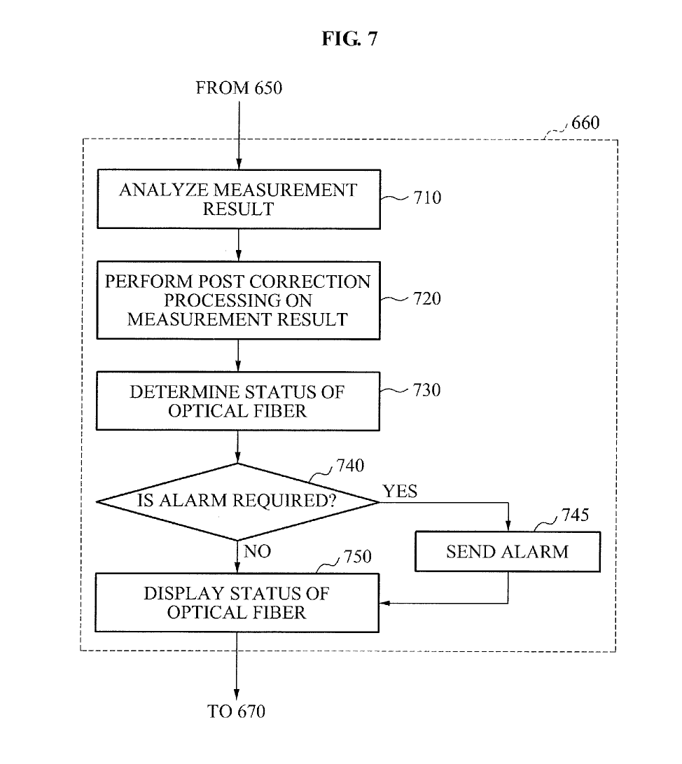

FIG. 7 is a flowchart illustrating a method of monitoring a status of an optical fiber according to an embodiment of the present invention. Operations 710 through 750 may be included in operation 660 described with reference to FIG. 6.

Referring to FIG. 7, in operation 710, the optical fiber monitor 340 analyzes a measurement result stored in a storage medium in operation 650.

In operation 720, the optical fiber monitor 340 performs post correction processing on the measurement result analyzed in operation 710.

In operation 730, the optical fiber monitor 340 determines the status of the optical fiber based on the measurement result on which the post correction processing is performed in operation 720.

In operation 740, the optical fiber monitor 340 verifies whether the status of the optical fiber determined in operation 730 requires an alarm. For example, when the status of the optical fiber is less than a threshold value, the optical fiber monitor 340 may determine that the status of the optical fiber requires the alarm.

In operation 745, the optical fiber monitor 340 sends the alarm to inform a manager of an irregularity of the optical fiber. When the status of the optical fiber recovers from the irregularity to be greater than or equal to the threshold value due to handling by the manager or other factors, the optical fiber monitor 340 may cancel the alarm.

In operation 750, the optical fiber monitor 340 displays the status of the optical fiber determined in operation 730 and provides the status to the manager.

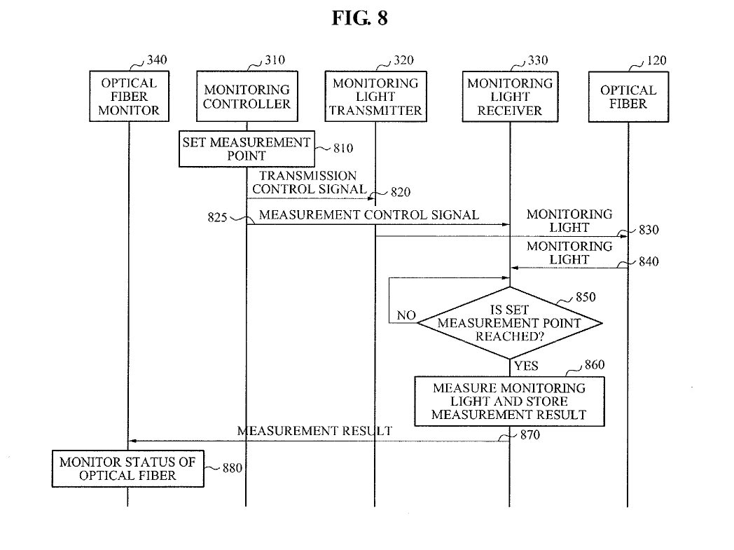

FIG. 8 is a flowchart illustrating operations performed between components of an optical fiber monitoring apparatus according to an embodiment of the present invention.

Referring to FIG. 8, in operation 810, the monitoring controller 310 sets a measurement point in time at which the monitoring light receiver 330 measures a received monitoring light based on measuring time sections generated by dividing an optical fiber monitoring time section. The monitoring controller 310 generates measurement control signals including the set measurement point. The monitoring controller 310 also generates transmission control signals to control the monitoring light transmitter 320 to transmit a monitoring light based on a number of the measuring time sections generated by dividing the optical fiber monitoring time section.

In operation 820, the monitoring controller 310 transmits the transmission control signals generated in operation 810 to the monitoring light transmitter 320.

In operation 825, the monitoring controller 310 transmits the measurement control signals generated in operation 810 to the monitoring light receiver 330.

In operation 830, the monitoring light transmitter 320 outputs the monitoring light to the optical fiber 120 based on the transmission control signals received in operation 820.

In operation 840, the monitoring light receiver 330 receives a portion of the monitoring light output in operation 830 and fed back from the optical fiber 120.

In operation 850, the monitoring light receiver 330 verifies whether the measurement point set in operation 810 is reached. In detail, when the measurement point is not reached, the monitoring light receiver 330 delays measurement of the monitoring light received in operation 840 until the measurement point set in operation 810 is reached. Conversely, when the measurement point is reached, the monitoring light receiver 330 performs operation 860.

In operation 860, the monitoring light receiver 330 measures the monitoring light received in operation 840. Here, the monitoring light receiver 330 measures a monitoring light received until an end point of a measuring time section and stores a result of the measuring in a storage medium.

In operation 870, the optical fiber monitor 340 loads the result of the measuring stored in the storage medium in operation 860. Here, the monitoring light receiver 330 deletes the result of the measuring stored in the storage medium after the loading is performed by the optical fiber monitor 340.

In operation 880, the optical fiber monitor 340 monitors a status of the optical fiber using the result of the measuring loaded in operation 870.

Operations 820 through 880 may be repetitively performed based on a number of the measuring time sections.

According to example embodiments of the present invention, all sections of an optical fiber may be monitored using a storage medium having a small capacity by dividing an optical fiber monitoring time section into a plurality of measuring time sections, delaying measurement and storage of a monitoring light fed back from the optical fiber based on the measuring time sections, and repeating the foregoing operations based on a number of the measuring time sections.

According to example embodiments of the present invention, a cost required for fabricating an optical fiber monitoring apparatus and a size of the optical fiber monitoring apparatus may be reduced because all sections of an optical fiber may be monitored using a storage medium having a small capacity.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An apparatus for monitoring an optical fiber, the apparatus comprising:
a monitoring light transmitter to continuously output a monitoring light to the optical fiber based on a number of measuring time sections generated by dividing an optical fiber monitoring time section;
a monitoring light receiver to receive a monitoring light fed back from the optical fiber, measure a monitoring light received based on different measuring time sections for each monitoring light, and store a result of the measuring in a storage medium; and
an optical fiber monitor to monitor a status of the optical fiber based on the result of the measuring stored in the storage medium.

2. The apparatus of claim 1, wherein the measuring time sections are generated by dividing the optical fiber monitoring time section based on a physical size of the storage medium.

3. The apparatus of claim 1, wherein the monitoring light receiver delays measurement of a received monitoring light until a start point of a measuring time section.

4. The apparatus of claim 1, wherein the monitoring light receiver measures a monitoring light received during a period of time spanning from a start point of a measuring time section to an end point of the measuring section, and stores a result of the measuring in the storage medium.

5. The apparatus of claim 1, wherein the result of the measuring comprises at least one of an optical intensity of a received monitoring light and a point in time at which the monitoring light is received.

6. The apparatus of claim 1, wherein the optical fiber monitor monitors the status of the optical fiber by analyzing measurement results stored in the storage medium during a time section spanning from an end point of a measuring time section to a point in time at which the monitoring light transmitter outputs a monitoring light again and during a time section spanning from a point in time at which the monitoring light transmitter outputs a monitoring light to a start point of a measuring time section.

7. An apparatus for monitoring an optical fiber, the apparatus comprising:
a measuring time section determiner to determine measuring time sections in which a monitoring light fed back from the optical fiber is to be measured based on measuring distance sections generated by dividing an optical fiber monitoring distance section;
a monitoring light transmitter to continuously output a monitoring light to the optical fiber based on a number of the measuring time sections;
a monitoring light receiver to receive the monitoring light fed back from the optical fiber, measure a monitoring light received based on different measuring time sections for each monitoring light, and store a result of the measuring in a storage medium; and
an optical fiber monitor to monitor a status of the optical fiber based on the result of the measuring stored in the storage medium.

8. The apparatus of claim 7, wherein the measuring distance sections are generated by dividing the optical fiber monitoring distance section based on a physical size of the storage medium.

9. The apparatus of claim 8, wherein the measuring distance sections are generated by dividing the optical fiber monitoring distance section based on a configuration of the optical fiber, and
a capacity of the storage medium is determined based on a longest measuring distance section among the measuring distance sections.

10. The apparatus of claim 7, wherein the monitoring light receiver delays measurement of a received monitoring light until a start point of a measuring time section.

11. A method of monitoring an optical fiber, the method comprising:
continuously outputting a monitoring light to the optical fiber based on a number of measuring time sections generated by dividing an optical fiber monitoring time section;
receiving a monitoring light fed back from the optical fiber;
measuring a monitoring light received based on different measuring time sections for each monitoring light and storing a result of the measuring in a storage medium; and
monitoring a status of the optical fiber based on the result of the measuring stored in the storage medium.

12. The method of claim 11, wherein the measuring time sections are generated by dividing the optical fiber monitoring time section based on a physical size of the storage medium.

13. The method of claim 11, wherein the receiving of the monitoring light comprises delaying measurement of a received monitoring light until a start point of a measuring time section.

14. The method of claim 11, wherein the receiving of the monitoring light comprises measuring a monitoring light received during a period of time spanning from a start point of a measuring time section to an end point of the measuring time section and storing a result of the measuring in the storage medium.

15. The method of claim 11, wherein the result of the measuring comprises at least one of an optical intensity of a received monitoring light and a point in time at which the monitoring light is received.

16. The method of claim 11, wherein the monitoring of the status of the optical fiber comprises analyzing measurement results stored in the storage medium and performing post correction processing on the measurement results during a time section spanning from an end point of a measuring time section to a point in time at which a monitoring light is output again to the optical fiber in the outputting of the monitoring light and during a time section spanning from a point in time at which a monitoring light is output again to the optical fiber in the outputting of the monitoring light to a start point of a measuring time section.
